(19) United States
(12) Patent Application Publication
(10) Pub. No.: US 2007/0070624 A1
(43) Pub. Date: Mar. 29, 2007

(54) Light-emitting diode assembly and light source device using same

(75) Inventor: Wen-Hsin Sun, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/478,114

(22) Filed: Jun. 28, 2006

(30) Foreign Application Priority Data
Sep. 23, 2005 (CN) 200510037489.0

(51) Int. Cl. F21V 11/00

(52) U.S. Cl. 362/240; 362/800; 362/252

(57) ABSTRACT

A light emitting diode assembly includes a supporter and a plurality of light emitting diodes, the supporter having a light emitting diode region, the light emitting diode region defining a plurality of concentric circles with radiuses Rₙ thereof satisfying the equation: Rₙ=n×r, where r represents a radius of the smallest circle, and n represents a sequence number of the circles in order from the smallest circle to the largest circle. The light emitting diodes are arranged in the light emitting diode region of the supporter, wherein, a number of light emitting diodes m are arranged in the smallest circle of the light emitting diode region of the supporter, and a number of light emitting diodes equaling (2n−1)×m are arranged in a circular region bounded by the circle number (n−1) and the circle number n of the supporter.

### BACKGROUND

1. Technical Field

The present invention relates generally to light-emitting devices, and more particularly to a light emitting diode (LED) assembly, and a light source device using the LED assembly.

2. Discussion of Related Art

In the field of illumination of light source, LEDs are being increasingly used instead of conventional incandescent bulbs, since LEDs have a longer service life, a better efficiency in the converting of electrical energy in the visible spectral range and, connected therewith, a lower heat emission and a lower space requirement overall.

Because of the lower luminance of an individual LED compared with an incandescent bulb, a plurality of LEDs shaped to form an arrangement must be constructed.

Referring to FIG. 4, a conventional LED arrangement 100 is consisted of a plurality of LEDs 112, 122. The LEDs 112 are disposed so as to constitute a fundamental arrangement pattern 1 10 corresponding to a luminous intensity distribution pattern. The LEDs 122 are provided to correct the luminous intensity distribution pattern of the fundamental arrangement pattern 110.

However, it is difficult to construct the LED arrangement 100 with uniform luminous intensity distribution, and the luminous area of LEDs 112 has large overlap section due to limited area between LEDs 112, so that not every LED 112 is used sufficiently.

What is needed, therefore, is to provide an LED arrangement having uniform luminous intensity distribution in each direction, and a light source device with LED arrangement having uniform luminous intensity distribution.

### SUMMARY

A preferred embodiment of the invention provides a light emitting diode assembly includes a supporter and many light emitting diodes. The supporter having a light emitting diode region, the light emitting diode region defining a plurality of concentric circles with radiuses Rₙ thereof satisfying the equation: Rₙ=n×r, where r represents a radius of the smallest circle, and n represents a sequence number of the circles in order from the smallest circle to the largest circle. The light emitting diodes are arranged in the light emitting diode region of the supporter, wherein, a number of light emitting diodes m are arranged in the smallest circle of the light emitting diode region of the supporter, and a number of light emitting diodes equaling (2n−1)×m are arranged in a circular region bounded by the circle number (n−1) and the circle number n of the supporter.

Another preferred embodiment of the invention provides a light source device, the light source device including a housing and a light emitting diode assembly received in the housing. The light emitting diode assembly including: a supporter having a light emitting diode region, the light emitting diode region defining a plurality of concentric circles with radiuses Rₙ thereof satisfying the equation: Rₙ=n×r, where r represents a radius of the smallest circle, and n represents a sequence number of the circles in order from the smallest circle to the largest circle, and a plurality of light emitting diodes arranged in the light emitting diode region of the supporter, wherein, a number of light emitting diodes m are arranged in the smallest circle of the light emitting diode region of the supporter, and a number of light emitting diodes (2n−1)×m are arranged in a circular region bounded by the circle number (n−1) and the circle number n of the supporter.

Other advantages and novel features will become more apparent from the following detailed description when taken in conjunction with the accompanying drawings.

### BRIEF DESCRIPTION OF THE DRAWINGS

The components in the drawings are not necessarily to scale, the emphasis instead being placed upon clearly illustrating the principles of the present light emitting diode assembly and light emitting device. Moreover, in the drawings, like reference numerals designate corresponding parts throughout the several views.

FIG. 1 is a schematic of a light emitting diode assembly according to a first preferred embodiment;

FIG. 2 is a schematic of a light emitting diode assembly according to a second preferred embodiment;

FIG. 3 is an isometric view of a light source device having the light emitting diode assembly of FIG. 1;

FIG. 4 is a schematic view of a conventional light emitting diode array.

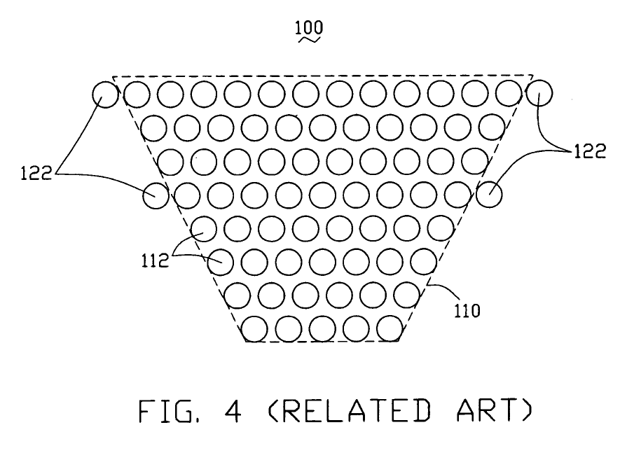

### DETAILED DESCRIPTION OF THE EMBODIMENTS

The present light emitting diode assembly generally includes a supporter and a plurality of light emitting diodes. The supporter having a light emitting diode region, the light emitting diode region defining a plurality of concentric circles with radiuses Rₙ thereof satisfying the equation: Rₙ=n×r, where r represents a radius of the smallest circle, and n represents a sequence number of the circles in order from the smallest circle to the largest circle. The light emitting diodes are arranged in the light emitting diode region of the supporter, wherein, a number of light emitting diodes m are arranged in the smallest circle of the light emitting diode region of the supporter, and a number of light emitting diodes (2n−1)×m are arranged in a circular region bounded by the circle number (n−1) and the circle number n of the supporter.

The following is an elucidation about light emitting diode assembly structure for comprehending how the light emitting diodes are located evenly.

The supporter has a light emitting diode region which defines a plurality of concentric circles with radiuses Rₙ thereof satisfying the equation: Rₙ=n×r, where r represents a radius of the smallest circle, and n represents a sequence number of the circles in order from the smallest circle to the largest circle.

Radiuses of the concentric circles are individually defined as r, 2r, 3r, . . . (n−1)r, nr from the smallest circle to the largest circle.

The area S₁ surrounded by the smallest circle is:
S₁=π×r² (1)

The area S₂ surrounded by the second circle is:
S₂=π×(2r)² (2)

The area S₃ surrounded by the third circle is:
S₃=π×(3r)² (3)

The area S₍ₙ₋₁₎ surrounded by the (n−1) circle is:
S₍ₙ₋₁₎=π×[(n−1)r]² (4)

The area Sₙ surrounded by the n circle is:
Sₙ=π×(nr)² (5)

According to formulas (1) and (2), the area of a first annulus S₁₂ surrounded by the smallest circle and the second circle is:
S₁₂=S₂−S₁=3×π×r² (6)

According to formulas (2) and (3), the area of a second annulus S₂₃ surrounded by the second circle and the third circle is:
S₂₃=S₃−S₂=5×π×r² (7)

According to formulas (4) and (5), the area of a (n−1) annulus S₍ₙ₋₁₎ₙ surrounded by the (n−1) circle and the n circle is:
S₍ₙ₋₁₎ₙ=Sₙ−S₍ₙ₋₁₎=(2n−1)×π×r² (8)

And the circular area surrounded by the smallest circle is carved up with a number of sub-areas m following the radial direction, a light emitting diode is arranged in one sub-areas, so according to formula (1), the area of sub-area Sᵢ is:
Sᵢ=S₁/m=π×r²/m (9)

According to formulas (6) and (9), the first annulus having a number of sub-areas in circular direction m₁, area of the sub-area is Sᵢ, wherein m₁ is:
m₁=S₁₂/Sᵢ=5×m (10)

According to formulas (7) and (9), the second annulus having a number of sub-areas in circular direction m₂, area of the sub-area is Sᵢ, wherein m₂ is:
m₂=S₂₃/Sᵢ=5×m (11)

According to formulas (8) and (9), the (n−1) annulus having a number of sub-area in a circular direction m₍ₙ₋₁₎, area of the sub-area is Sᵢ, wherein m₍ₙ₋₁₎ is:
m₍ₙ₋₁₎=S₍ₙ₋₁₎ₙ/Sᵢ=(2n−1)×m (12)

According to formulas (9), (10), (11), and (12), the light emitting diode assembly having a number of sub-areas in a circular direction mⱼ, area of the sub-area is Sᵢ, wherein mⱼ is:
mⱼ=m+m₁+m₂+ . . . +m₍ₙ₋₁₎=m×n² (13)

Referring to description above, a number of m×n² light emitting diodes is arranged in the light emitting diode region of the supporter. A number of light emitting diodes m is arranged in the smallest circle of the light emitting diode region of the supporter, a number of light emitting diodes (2n−1)×m are arranged in a circular region bounded by the circle number (n−1) and the circle number n of the supporter.

Reference will now be made to the drawings to describe embodiments of the present light emitting diode assembly.

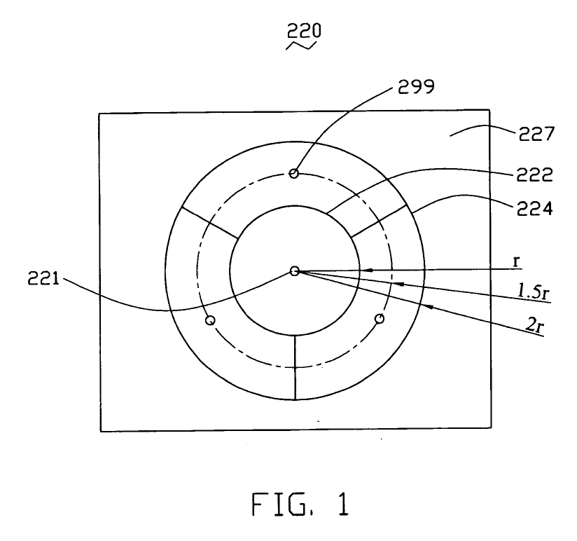

Referring to FIG. 1, when n is equal to 2 and m is equal to 1 light emitting diode assembly 220 including a supporter 227 and four LEDs 229 that are arranged on the supporter 227.

The supporter 227 has a first circle 222 and a second circle 224. A point 221 acts as the centre of the first circle 222 and the second circle 224. The radius of the first circle 222 is r, the area surrounded by the first circle 222 is π×r²; the radius of the second circle 224 is 2r, the area surrounded by the second circle 224 is 4×π×r², the area of annulus surrounded by the first circle 222 and the second circle 224 is 3×π×r². An LED 299 is placed on the point 221 and three LEDs 299 are equidistantly arranged in the annulus area, at the same time, three LEDs 299 are spaced from each of adjacent circles thereof at a same distance. As a result of this the light emitting diode assembly 220 has uniform luminous intensity distribution in each direction.

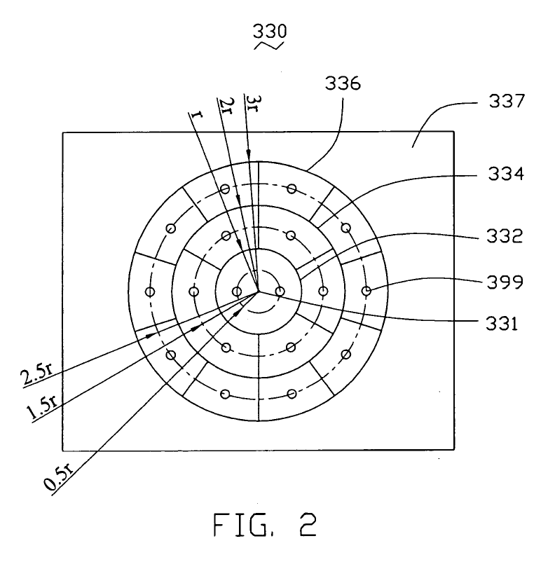

Referring to FIG. 2, when n is equal to 3 and m is equal to 2 light emitting diode assembly 330 each including a supporter 337 and eighteen LEDs 339 that are placed on the supporter 337.

The supporter 337 has a first circle 332, a second circle 334 and a third circle 336. A point 331 acts as the centre of the first circle 332, the second circle 334 and the third circle 336. The radius of the first circle 332 is r, the area surrounded by the first circle 332 is π×r²; the radius of the second circle 334 is 2r, the area surrounded by the second circle 334 is 4×π×r²; the radius of the third circle 336 is 3r, the area surrounded by the third circle 336 is 9×π×r²; the area of annulus surrounded by the first circle 332 and the second circle 334 is 3×π×r²; the area of annulus surrounded by the second circle 334 and the third circle 336 is 5×π×r². Two LEDs 339 are arranged evenly in the circular region surrounded by the first circle 332; six LEDs 339 are equidistantly arranged evenly in the annulus area surrounded by the first circle 332 and the second circle 334, at the same time, ten LEDs 339 are equidistantly arranged in the annulus area surrounded by the second circle 334 and the third circle 336, LEDs 399 are spaced from each of adjacent circles thereof by a same distance. As a result of this the light emitting diode arrangement 330 has uniform luminous intensity distribution in each direction.

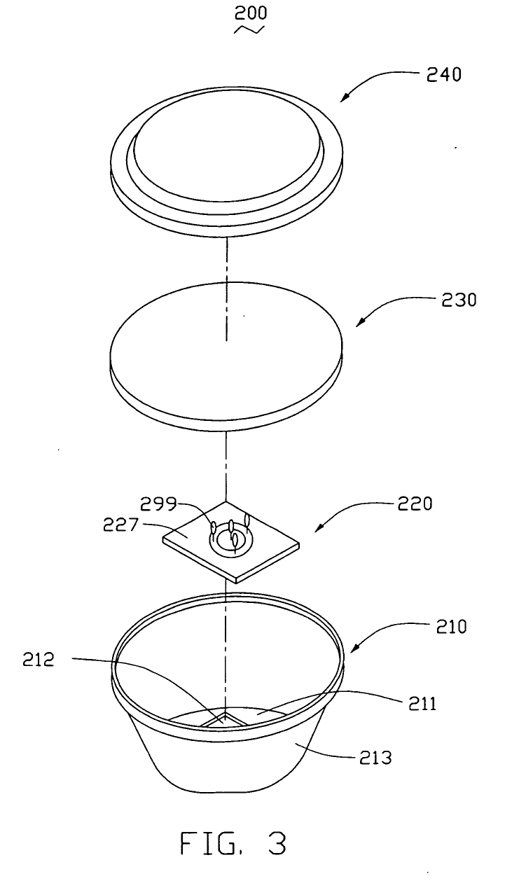

Referring to FIG. 3, a light source 200 including: a housing 210, a light emitting diode assembly 220, a supporter 227 placed at the bottom of the housing 210, a condenser lens 230 and a light-permeable cover 240. The housing 210 is frustoconical in shape and has a round bottom 211 and a wall 213 defining an opening having a larger diameter than that of the bottom 211, and the light emitting diode assembly 220 is facing the opening. A groove 212 is placed in the middle of the bottom 211. A plurality of light emitting diodes 299 of the light emitting diode assembly 220 are arranged on the supporter 227, the supporter 227 can be fixed in the groove 212. The condenser lens 230 is arranged adjacent to the opening of the housing 210 and the light-permeable cover 240 is shaped to cover the opening of the housing 210. The light source device 200 uses the light emitting diode assembly 220, so that light is emitted in a predetermined luminous intensity distribution pattern. The light source device 200 can use a light emitting diode assembly having other combinations of m and n.

It is understood that the various above-described embodiments and methods are intended to illustrate rather than limit the invention. Variations may be made to the embodiments and methods without departing from the spirit of the invention. Accordingly, it is appropriate that the appended claims be construed broadly and in a manner consistent with the scope of the invention.

What is claimed is:

1. A light emitting diode assembly, comprising:
a supporter having a light emitting diode region, the light emitting diode region defining a plurality of concentric circles with radiuses R, thereof satisfying the equation: Rₙ=n×r, where r represents a radius of the smallest circle, and n represents a sequence number of the circles in order from the smallest circle to the largest circle, and
a plurality of light emitting diodes are arranged in the light emitting diode region of the supporter, wherein, a number of light emitting diodes m are arranged in the smallest circle of the light emitting diode region of the supporter, and a number of light emitting diodes equaling (2n−1)×m are arranged in a circular region bounded by the circle number (n−1) and the circle number n of the supporter.

2. The light emitting diode assembly of claim 1, wherein m is equal to 1, and a light emitting diode is placed on the central point.

3. The light emitting diode assembly of claim 2, wherein the number of light emitting diodes equaling (2n−1)×m are equidistantly arranged in the circular region.

4. The light emitting diode assembly of claim 3, wherein each of the (2n−1)×m light emitting diodes are spaced from each of adjacent circles thereof by a same distance.

5. The light emitting diode assembly of claim 1, wherein m is greater than 1, and the number of light emitting diodes m are equidistantly arranged in the smallest circle.

6. The light emitting diode assembly of claim 5, wherein the number of light emitting diodes equaling (2n−1)×m are equidistantly arranged in the circular region.

7. The light emitting diode assembly of claim 5, wherein each of the (2n−1)×m light emitting diodes is spaced from each of adjacent circles thereof by a same distance.

8. A light source device, comprising:
a housing; and
an light emitting diode assembly received in the housing, the light emitting diode assembly comprising
a supporter having a light emitting diode region, the light emitting diode region defining a plurality of concentric circles with radiuses Rₙ thereof satisfying the equation: Rₙ=n×r, where r represents a radius of the smallest circle, and n represents a sequence number of the circles in order from the smallest circle to the largest circle; and
a plurality of light emitting diodes arranged in the light emitting diode region of the supporter, wherein, a number of light emitting diodes equal to m are arranged in the smallest circle of the light emitting diode region of the supporter, and a number equaling (2n−1)×m of light emitting diodes are arranged in a circular region bounded by the circle number (n−1) and the circle number n of the supporter.

9. The light source of claim 8, wherein the housing is frustoconical in shape and has an opening with the light emitting diodes facing the opening.

10. The light source of claim 9, further comprising a condenser lens arranged adjacent the opening of the housing.

11. The light source of claim 9, further comprising a light-permeable cover shaped to cover the opening of the housing.

12. The light source of claim 8, wherein m is equal to 1, a light emitting diode is placed on the central point.

13. The light source of claim 12, wherein the number of light emitting diodes equaling (2n−1)×m are equidistantly arranged in the circular region.

14. The light source of claim 13, wherein each of the (2n−1)×m light emitting diodes is spaced from each of adjacent circles thereof at a same distance.

15. The light source of claim 8, wherein m is greater than 1, and the number of light emitting diodes m are equidistantly arranged in the smallest circle.

16. The light source of claim 15, wherein the number of light emitting diodes equaling (2n−1)×m are equidistantly arranged in the circular region.

17. The light source of claim 15, wherein each of the light emitting diodes (2n−1)×m are spaced from each of adjacent circles thereof at a same distance.
